(19) United States
(12) Patent Application Publication
(10) Pub. No.: US 2017/0288868 A1
(43) Pub. Date: Oct. 5, 2017

(54) WI-FI ENCRYPTION DEVICE BASED ON IRIS IDENTIFICATION

(71) Applicants: Le Holdings (Beijing) Co., Ltd., Beijing (CN); Lemobile Information Technology (Beijing) Co., Ltd., Beijing (CN)

(72) Inventor: Baoliang SONG, Beijing (CN)

(73) Assignees: Le Holdings (Beijing) Co., Ltd., Beijing (CN); Lemobile Information Technology (Beijing) Co., Ltd., Beijing (CN)

(21) Appl. No.: 15/241,364

(22) Filed: Aug. 19, 2016

Related U.S. Application Data
(63) Continuation of application No. PCT/CN2016/088474, filed on Jul. 4, 2016.

(30) Foreign Application Priority Data
Mar. 30, 2016 (CN) 201620261004.X

(51) Int. Cl. H04L 9/08; H04N 5/225; H04L 9/14; H04W 12/06; H04W 12/02; H04W 12/04; G06K 9/00; H04N 5/33

(52) U.S. Cl. CPC H04L 9/0866; G06K 9/00604; G06K 9/00617; H04N 5/2257; H04N 5/33; H04W 12/06; H04W 12/02; H04W 12/04; H04L 9/14

(57) ABSTRACT

The embodiment of the present disclosure discloses a Wi-Fi encryption device based on iris identification, which includes: a camera control module, an iris camera, an iris identification module, a key generation module and a Wi-Fi key module. The iris camera is coupled to the iris identification module, the iris identification module is coupled to the key generation module, the key generation module is coupled to the Wi-Fi key module, and the camera control module is coupled to the iris camera.

### CROSS-REFERENCE TO RELATED APPLICATIONS

This application is a continuation of international application No. PCT/CN2016/088474 filed on Jul. 4, 2016, and claims priority to Chinese Patent Application No. 201620261004.X filed on Mar. 30, 2016 in China Patent Office, entitled “WI-FI ENCRYPTION DEVICE BASED ON IRIS IDENTIFICATION”, both of which are incorporated herein by reference in their entireties.

### FIELD OF TECHNOLOGY

The present disclosure relates to a field of secure encryption communication, and in particular, to a Wi-Fi encryption device based on iris identification.

### BACKGROUND

A Wi-Fi is a technology for wirelessly interconnecting terminals such as personal computers, hand-held apparatuses (for example, pads and mobile phones), and the like. In fact, the Wi-Fi is a high-frequency wireless electrical signal. In order to prevent a stranger from using the network, a private user of a Wi-Fi may usually set a password for the Wi-Fi.

In the prior art, a user generally inputs a combination of alphabets or numbers as a key via a keyboard input apparatus. Such an encryption way has following defects: 1) the user needs to combine alphabets or numbers with the aid of memorization, while sometimes the user may forget the password, which will brings about many troubles; 2) a key combined of alphabets or numbers is easily cracked by some professional password cracking softwares, and hence its security level is lower. As a result, there is a need of an unforgettable Wi-Fi password setting mode that is secure and easily operable.

### SUMMARY

Therefore, the disclosure discloses a Wi-Fi encryption device based on iris identification, which can set a Wi-Fi password by using uniqueness of iris characteristic for each person. Furthermore, the Wi-Fi encryption device based on iris identification may be simply unlocked and easily operated, and the security and privacy thereof may be better guaranteed.

Therefore, it is an object of the present disclosure to provide a Wi-Fi encryption device based on iris identification. According to the uniqueness of iris characteristic information of eyes of a human body, the iris characteristic information of the eyes is set, by a microprocessor module, an iris camera, an iris identification module, a key generation module and a Wi-Fi module, as a connection key for a router to which a mobile phone is connected. When the mobile phone is to be connected to the router, the user will perform verification with the iris characteristic information. If the iris characteristic information fits a preset key, the mobile phone is allowed to access the router.

To attain the above object, an embodiment of the disclosure provides a mobile phone of encrypting Wi-Fi based on iris identification, which includes: an iris camera disposed at a front end of a housing of the mobile phone, and an iris identification module, a key generation module and a Wi-Fi key module that are disposed on a mainboard of the mobile phone; wherein,
an output end of the iris camera is coupled to an input end of the iris identification module;
an output end of the iris identification module is coupled to an input end of the key generation module;
an output end of the key generation module is coupled to an input end of the Wi-Fi key module;
the iris camera is configured for collecting an iris image of a human body and transferring the iris image to the iris identification module;
the iris identification module is configured for extracting iris characteristic information from the iris image and transferring the iris characteristic information to the key generation module;
the key generation module is configured for generating a key according to the iris characteristic information and transferring the key to the Wi-Fi key module; and
the Wi-Fi key module is configured for setting the key received as a Wi-Fi connection key for a router to which the mobile phone is currently connected.

As described above, in the embodiment of the disclosure, the iris characteristic information is set as a connection key for a router to which a mobile phone is connected. When an apparatus accesses a router, it is required to perform verification with the iris characteristic information. The iris characteristic is set as a Wi-Fi password according to the uniqueness of the iris characteristic for each person, so that a user can log on a Wi-Fi network more quickly and conveniently, and the security and privacy can also be guaranteed.

### BRIEF DESCRIPTION OF THE DRAWING

In order to more clearly illustrate the technical solutions of the embodiments of the present disclosure or of the prior art, the drawings needed in the description of the embodiments or the prior art will be briefly introduced below. Apparently, the drawings in the description below are only some embodiments of the present disclosure, and other drawings may also be obtained by one of ordinary skills in the art according to these drawings without creative work.

FIG. 1 is a schematic diagram showing an overall structural design of a Wi-Fi encryption device based on iris identification according to an embodiment of the disclosure.

### DETAILED DESCRIPTION

In order to make the objects, technical solutions and advantages of the disclosure more apparent, the disclosure will be further described in detail below in conjunction with specific embodiments with reference to the drawings. It should be understood that, these descriptions are exemplary only, rather than limiting the scope of the disclosure. Moreover, in the illustration below, in order to avoid unnecessarily confusing the concept of the disclosure, the description of well-know structures and technologies will be omitted.

A Wi-Fi (Wireless Fidelity) is a technology for wirelessly interconnecting terminals such as personal computers, hand-held apparatuses (for example, pads and mobile phones) and the like. In fact, The Wi-Fi is a high-frequency wireless electrical signal. [1] The Wireless Fidelity is a brand of a wireless network communication technology owned by the Wi-Fi Alliance. A purpose thereof is to improve communication among wireless network products based on IEEE 802.11 standard. A local area network employing IEEE 802.11 series protocol is sometimes referred as the Wireless Fidelity.

An outside view of a human eye is consisted of three parts: a sclera, an iris and a pupil. The sclera is the white part on the periphery of an eyeball, and occupies about 30% of overall area; the pupil lies in the center of the eye, and occupies about 5% of the overall area; and the iris between the sclera and the pupil contains the most abundant texture information and occupies about 65% of the overall area. Seeing from the appearance, the iris is consisted of many gland crypts, gauffers and pigmented spots, and it is one of the most unique structures in human body. The forming of the iris is determined by genetic gene, and the shape, physiology, color and overall appearance of the iris are determined by gene expression of a human body. When a human grow to about eight months, the iris will basically grow to a sufficient size and enter a relatively stable period. The appearance of the iris will remain unchanged for tens of years, unless there occurs an infrequent abnormal status, or a great physical or spiritual hurt. On the other hand, the iris can be seen from outside, and at the same time, it is an interior tissue that lies behind the cornea. It requires a very fine surgery to change the appearance of the iris at the risk of sight damage. The high uniqueness, stability and constancy of the iris are the material basis on which the iris can be used for identity authentication. Therefore, in an embodiment of the disclosure, identification and authentication are performed on Wi-Fi communication based on an iris identification technology. Thus, unauthorized using of a network and stealing of individual information may be prevented.

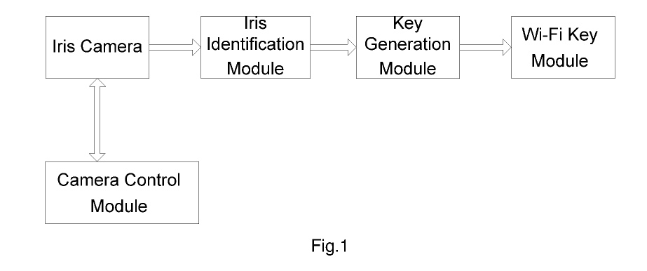

FIG. 1 is a schematic diagram showing an overall structural design of a Wi-Fi encryption device based on iris identification according to an embodiment of the disclosure.

As shown in FIG. 1, the embodiment of the disclosure includes: a camera control module, an iris camera, an iris identification module, a key generation module and Wi-Fi key module.

An output end of the iris camera is coupled to an input end of the iris identification module;

An output end of the iris identification module is coupled to an input end of the key generation module;

An output end of the key generation module is coupled to an input end of the Wi-Fi key module;

The iris camera is configured for collecting an iris image of a human body and transferring the iris image to the iris identification module;

The iris identification module is configured for extracting iris characteristic information from the iris image and transferring the iris characteristic information to the key generation module;

The key generation module is configured for generating a key according to the iris characteristic information and transferring the key to the Wi-Fi key module;

The Wi-Fi key module is configured for setting the key received as a Wi-Fi connection key for a router to which the mobile phone is currently connected.

When a household router is used for the first time or is used for the first time after initialization, an encryption operation will be performed on the router via a mobile phone so as to prevent an outsider from occupying the bandwidth and influencing a transmission rate of the network used by an insider.

First of all, a distance range from an iris camera to a human eye should be set. When the mobile phone reaches this distance range, the camera of the mobile phone is turned on to acquire eye information of the human body.

When the router accessed by the mobile phone is used for the first time or is used for the first time after initialization, the Wi-Fi key module may send a request to the iris camera to turn on the iris camera for acquiring the eye information of the human body.

When a distance from the infrared camera to the human eye reaches a preset distance range, the infrared camera is turned on to acquire the eye information of the human body, and the distance sensor transfers the acquired eye information to the iris identification module.

The iris identification module extracts the iris characteristic information required from the received eye information of the human body. The information extracted includes: a shape and location of the pupil, a shape of an autonomic nerve wreath, and a shape and location of a dim spot. Then, the iris identification module transfers the iris characteristic information extracted to the key generation module.

The key generation module generates a key from the iris characteristic information received and transfers the key to the Wi-Fi key module.

The Wi-Fi key module sets the key received as a Wi-Fi connection key for a router to which the mobile phone is currently connected.

The Wi-Fi key module may set a plurality of Wi-Fi connection keys for the router to which the mobile phone is connected, wherein the plurality of Wi-Fi connection keys are used for the connection to the router.

When an apparatus is to be connected to the router, it will successfully access the router so long as any one of at least one connection key set by the Wi-Fi key module is verified.

The device embodiments described above are only illustrative, wherein an unit illustrated as a separate part may be or may not be physically separated, and a part illustrated as an unit may be or may not be a physical unit, that is, it may be located at one place or may be distributed on a plurality of network modules. A part of or all the modules may be selected according to actual demand to implement the object of the embodiment. It will be understood and implemented by one of ordinary skills in the art without creative work.

According to above description of embodiments, one of ordinary skills in the art may clearly understand that various embodiments may be achieved by means of softwares and suitably general hardware platforms, and may also be by hardwares. Based on above understanding, above technical solutions or a part contributed to the prior art may be essentially embodied in a form of software product. The software product may be stored in readable storage media, such as ROM/RAM, disk, optical disk and the like, and includes a number of instructions such that a computer device (which may be a personal computer, server, network device or the like) performs methods described in various embodiments or some parts of embodiments.

Finally, it should be illustrated that the above embodiments are only used for illustrating the technical solutions of the present disclosure, rather than limiting the scope thereof; although the present disclosure has been illustrated in detail by referring to the above embodiments, it should be understood by one of ordinary skills that, modifications may still be made to the technical solution recorded in each of the above embodiments, or equivalent substitutions may be made to a part of the technical characteristics thereof; moreover, these modifications or substitutions will not make the nature of corresponding technical solution depart from the spirit and scope of the technical solutions of each embodiment of the present disclosure.

What is claimed is:

1. A mobile phone of encrypting a Wi-Fi based on iris identification, comprising:
an iris camera disposed at a front end of a housing of the mobile phone, and
an iris identification module, a key generation module and a Wi-Fi key module that are disposed on a mainboard of the mobile phone, wherein,
an output end of the iris camera is coupled to an input end of the iris identification module;
an output end of the iris identification module is coupled to an input end of the key generation module;
an output end of the key generation module is coupled to an input end of the Wi-Fi key module;
the iris camera is configured for collecting an iris image of a human body and transferring the iris image to the iris identification module;
the iris identification module is configured for extracting iris characteristic information from the iris image and transferring the iris characteristic information to the key generation module;
the key generation module is configured for generating a key according to the iris characteristic information and transferring the key to the Wi-Fi key module; and
the Wi-Fi key module is configured for setting the key received as a Wi-Fi connection key for a router to which the mobile phone is currently connected.

2. The mobile phone according to claim 1, wherein, the mainboard of the mobile phone is provided with a camera control module, and the iris camera comprises an infrared camera and a distance sensor that are disposed at the front end of the housing of the mobile phone, wherein,
an output end of the distance sensor is coupled to an input end of the camera control module, and an output end of the camera control module is coupled to an input end of the infrared camera.

3. The mobile phone according to claim 2, wherein,
the distance sensor transfers measured distance information between a human face and the infrared camera to the camera control module; and
the camera control module compares the distance information with a preset distance range, and sends a turn-on instruction to the infrared camera if the distance information meets the distance range.

4. The mobile phone according to claim 1, wherein,
the Wi-Fi key module sets a plurality of keys for the router to which the mobile phone is currently connected.

5. The mobile phone according to claim 4, wherein,
the Wi-Fi key module is coupled to the router.
